(19) United States
(12) Patent Application Publication
(10) Pub. No.: US 2011/0011162 A1
(43) Pub. Date: Jan. 20, 2011

(54) DEVICE AND METHOD FOR INSPECTING BOTTLES OR SIMILAR CONTAINERS

(76) Inventor: Jürgen HERRMANN, Rosenheim (DE)

Correspondence Address: NILS H. LJUNGMAN & ASSOCIATES, P. O. BOX 130, GREENSBURG, PA, 15601-0130, US

(21) Appl. No.: 12/818,593

(22) Filed: Jun. 18, 2010

Related U.S. Application Data
(63) Continuation-in-part of application No. PCT/EP2008/008838, filed on Oct. 18, 2008.

(30) Foreign Application Priority Data
Dec. 21, 2007 (DE) 102007062812.0

(51) Int. Cl. G01N 7/00

(52) U.S. Cl. 73/31.03

(57) ABSTRACT

The present application relates to a device for inspecting bottles or similar containers by introducing an inspection and/or monitoring fluid into said containers and by analysis, by an inspection station disposed on a transport path for the containers, of gas and/or vapor reaction products potentially generated in the interior of the container, at least two inspection stations at least for the analysis of the gas and/or vapor production products being disposed one after the other in the transport direction of the transport path.

### CONTINUING APPLICATION DATA

This application is a Continuation-In-Part application of International Patent Application No. PCT/EP2008/008838, filed on Oct. 18, 2008, which claims priority from Federal Republic of Germany Patent Application No. 10 2007 062 812.0, filed on Dec. 21, 2007. International Patent Application No. PCT/EP2008/008838 was pending as of the filing date of this application. The United States was an elected state in International Patent Application No. PCT/EP2008/008838.

### BACKGROUND

1. Technical Field

The present application relates to a device according to the preamble of Claim 1 and to a method according to the preamble of Claim 11.

2. Background Information

Background information is for informational purposes only and does not necessarily admit that subsequently mentioned information and publications are prior art.

Devices are known for inspecting bottles or similar containers by introducing, for example, a liquid inspection and/or reaction medium into the respective container, by removing a gaseous and/or vaporous container sample from the interior of the container after expiry of a predetermined reaction time, as well as through analysis of the respective container sample for any reaction products that may be present generated by the reaction of the inspection and/or reaction medium with any contamination present in the interior of a container. Some inspection stations may be capable of introducing a liquid inspection and/or reaction medium (inspection or reaction liquid) into containers being moved past on a conveyor, by means of which however the removal of the respective container sample can also be effected.

### OBJECT OR OBJECTS

An object of the present application is to provide a device as well as a method for inspecting containers by introducing an inspection and/or reaction medium and through analysis of a container sample removed, making this inspection possible in a reliable manner even where the output is high, i.e. where there is a high number of containers inspected per unit time.

### SUMMARY

This object is achieved by a device corresponding to Claim 1. A method for inspecting containers is the object of Claim 11.

In one possible embodiment of the present application, in which two inspections stations are provided, it is possible for container samples from a portion of the containers supplied to the device to be removed at each inspection station, but in such a manner that the number of container samples removed is identical or substantially identical, in its turn, to the number of containers, i.e. when viewed overall one container sample has been removed from each container. By using at least two inspection stations, therefore, the number of containers to be treated in each inspection station is reduced, thereby making possible a considerable increase in the overall output of the device. In at least one possible embodiment of the present application, this increase may possibly be marked when the inspection stations are used at the same time for introducing the inspection and/or reaction medium into the container.

### BRIEF DESCRIPTION OF THE DRAWINGS

Further developments, embodiments, and application possibilities of the present application proceed from both the subsequent description of possible embodiments and from the Figures. In this case, the described and/or graphically represented features are, in principle, objects of the present application, either individually or in arbitrary combination. The present application is described below by way of the Figures of possible embodiments, in which, in detail:

FIG. 1 shows a simplified representation and top view of an inspection device for bottles or similar containers;

FIG. 2 shows a side view of an inspection head of the device in FIG. 1; and

FIG. 3 shows a representation as in FIG. 1 of another specific embodiment of the inspection device according to the present application.

### DESCRIPTION OF EMBODIMENT OR EMBODIMENTS

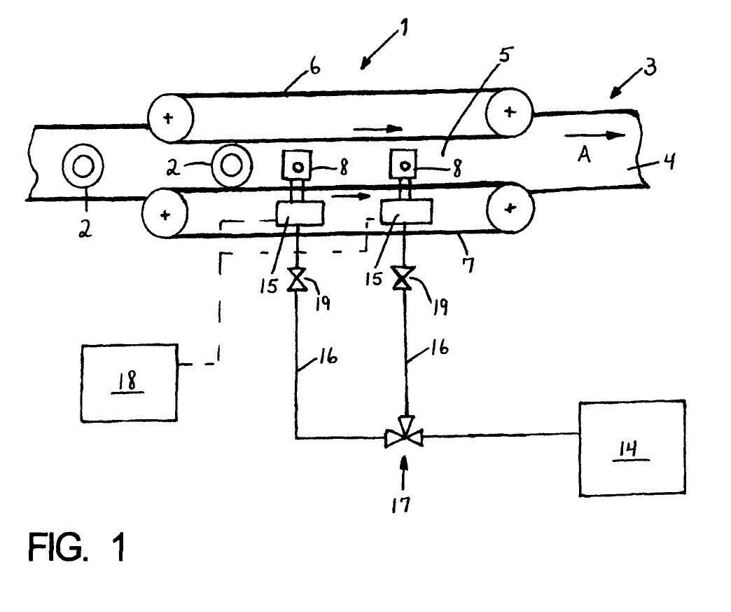

The device identified in general in FIG. 1 with the reference 1 is used for inspecting bottles 2 or similar containers by introducing an inspection and/or reaction medium in the form of an inspection and/or reaction liquid into each bottle 2 and by removing a gaseous and/or vaporous container sample from the respective bottle 2 after introducing the inspection and/or reaction liquid as well as through gas analysis of the container sample for gaseous and/or vaporous reaction products in said container sample.

The inspection device 1, in the case of the possible embodiment represented, comprises, among other things, a conveyor 3 with a conveyor belt 4, on which the bottles 2 to be inspected are moved standing upright, i.e. with their bottle axis oriented in the vertical direction, in the direction of the arrow A in the form of a single-track bottle flow on a transport section 5. Two support belts 6 and 7, driven in each case in an endlessly circulating manner, are provided on both sides of the transport section 5. The support belts 6 and 7 are oriented with their loop planes in each case in vertical or substantially vertical planes. The support belts 6 and 7 are driven in opposing directions in such a manner that the lengths of the support belts 6 and 7 that define the transport section 5 in a lateral manner and support the bottles 2 on said transport section 5 move in the transport direction A and the bottles 2 are held in each case, for example in a clamping manner, between said support belts 6 and 7.

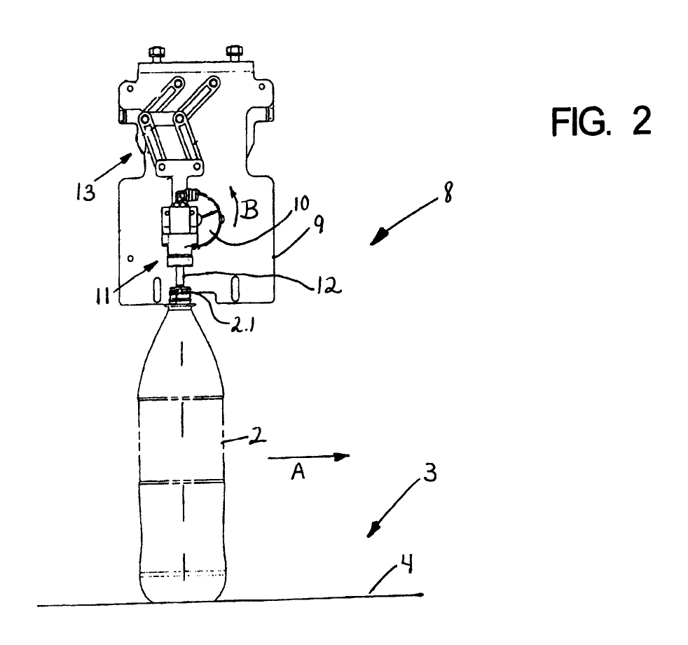

Two inspection stations 8 are provided on the transport section 5 offset one relative to the other in the transport direction A. The inspection stations may be identical or substantially identical, and one of which is represented in FIG. 2. Each inspection station 8 essentially comprises a carrier 9 retained on a frame of the inspection device 1, on which carrier 9 a crank wheel 10 is mounted so as to be rotatable about a horizontal or substantially horizontal axis at right angles to the direction of transport A. An injection and analysis head 11 is mounted on the crank wheel 10 eccentrically relative to the crank wheel axis. The injection and analysis head 11 comprises, among other things, a nozzle tube 12, which is used for introducing the inspection and/or reaction liquid into the respective bottle 2 as well as also for sucking out the gaseous and/or vaporous container sample from the bottle 2 for the gas analysis of a reaction product.

The crank wheel 10 may comprise a drive that is synchronous or substantially synchronous with the support belts 6 and 7. Consequently with the movement of the bottles 2, in the direction of the arrow B in FIG. 2, the injection and analysis head 11 is moved such that whenever a bottle 2 has reached the inspection station 8, the injection and analysis head 11 is moved downwards to introduce the nozzle tube 12 through the bottle mouth 2.1 into the relevant bottle 2 and, at the same time, is also entrained with the bottle 2 moving in the direction of transport A. At the first immersion of the nozzle tube 12 into the respective bottle 2 or even shortly prior to this, the introducing of the inspection and/or reaction liquid is effected and following this, with the nozzle tube 12 still immersed into the bottle 2, after a sufficient reaction time, the sucking up of the container sample out of the bottle 2. The nozzle tube 12 may comprise two separate channels for this purpose for example, one channel for introducing the inspection and reaction liquid and another channel for sucking up the gaseous and/or vaporous container sample.

Once the container sample has been sucked up, with the bottle 2 continuing to the move in the direction of transport A, the nozzle tube 12 is moved back out of the bottle 2 through the rotational movement of the crank wheel 10. With the crank wheel 10 circulating, consequently the injection and analysis head 11 carries out a lifting movement which is made up by a vertical and horizontal component. A double parallel or substantially parallel guiding means 13 that acts between the carrier 9 and the injection and analysis head 11 essentially ensures or promotes that the nozzle tube 12, with the movement of the injection and analysis head 11, is oriented continuously or substantially continuously with its axis in the vertical direction.

Once the inspection and/or reaction liquid has been introduced into a bottle 2, a certain reaction time is necessary and/or desired before the gaseous and/or vaporous container sample is available and can be sucked up via the injection and analysis head, i.e. said reaction time completely determines the length of the inspection necessary and/or desired for the inspection of each bottle 2. In order to reduce this length of inspection, the inspection and/or reaction liquid is possibly introduced into the bottles 2 in the heated-up or heated state, nevertheless the reaction time is predetermined by the available inspection and/or reaction liquids and cannot be reduced in an arbitrary manner. In order nevertheless to obtain a high output for the inspection device 1, two inspection stations 8 are provided one after the other in the direction of transport A. The control is effected in this case in such a way that the bottles 2 supplied to the transport section 5 are processed in an alternate manner by the one and the other inspection station 8, i.e. for example each first, third, fifth, etc. bottle 2 is processed by the first inspection station 8 when viewed in the direction of transport A and each second, fourth, sixth, etc. bottle 2 is processed by the second inspection station 8 when viewed in the direction of transport A.

The evaluation or analysis of the gaseous and/or vaporous container samples is effected for the two inspection stations 8 in a common gas analysis unit 14. For this purpose, each inspection station 8 does have independent control means 15, via which, among other things, the introducing of the inspection and/or reaction liquid into the bottle 2 is controlled and which also has means for sucking up and passing on the container samples to a connected analysis line 16 in each case, however the two inspection stations 8 are connected to a common inlet of the gas analysis unit 14 by means of the analysis lines 16 and a changeover valve 17. By means of a central control unit 18, the inspection stations 8 or their control means 15, as well as also the changeover valve 17, are controlled in such a manner that the gaseous and/or vaporous container samples supplied by the inspection stations 8 are analyzed one after the other chronologically in the gas analysis unit 14 and consequently the bottles 2 situated at the inspection stations 8 are inspected one after the other for any possible contamination or residues, for example for chemical and/or biological residues. The introducing of the inspection and/or reaction liquid into the bottles 2 situated at the inspection stations 8 is effected, for example, in a time staggered manner in such a way that during the reaction time at one inspection station 8, a container sample from the bottle 2 pending at the other inspection station 8 is supplied to the gas analysis unit 14 by means of the associated analysis line 16 and the changeover valve 17 and is analyzed there.

If a contaminated bottle 2 is ascertained during the inspection, said bottle is locked out of the bottle flow after passing the transport section 5, prompted by a corresponding signal supplied by the gas analysis unit 14.

In the case of the possible embodiment represented, additional control valves 19 are provided in the analysis lines 16, by means of which control valves the analysis lines 16 can be blocked for example by changing over the changeover valve 17. The control valves 19 are in one possible embodiment situated directly at the inspection stations 8 or on the injection and analysis heads 11 at that location. This means that it is then possible to rinse the respective length of the analysis lines 16 extending between the control valve 19 and the changeover valve 17 with an inert gaseous and/or vaporous medium, for example with CO₂ gas, nitrogen or sterile air, for removing any remains of the container samples by means of valves (not represented) for supplying and discharging the inert medium with the control valve 19 and the changeover valve 17 closed.

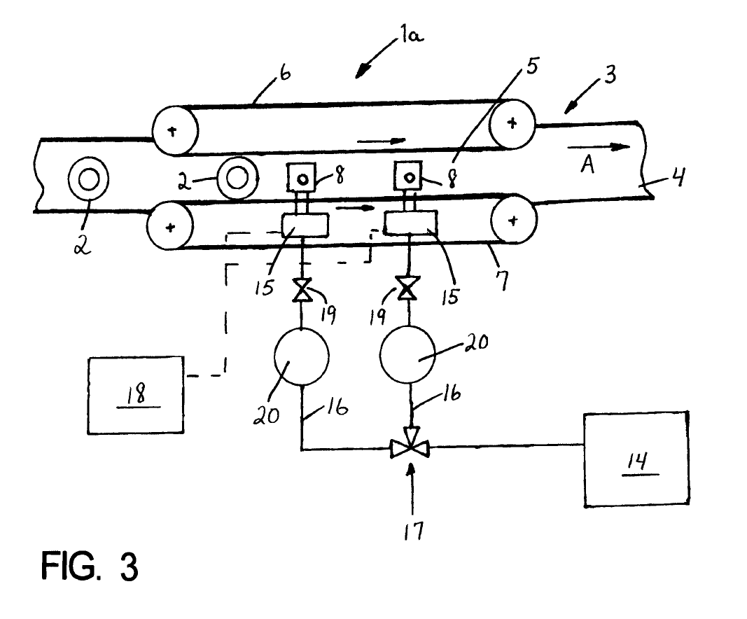

In a representation as in FIG. 1, FIG. 3 shows an inspection device 1a, in the form of another possible embodiment, said inspection device differing substantially from the inspection device 1 in that in the analysis lines 16 between the valve 19 and the changeover valve 17, there is provided in each case a tank or storage means 20 for the intermediate storing of the container sample obtained during the respective inspection or by the respective inspection station 8. The effect of the two storage means 20 is a decoupling in time of the analysis of the container samples from the processing of the bottles 2 at the inspection stations 8, i.e. of the introducing of the inspection and/or reaction liquid into the bottles 2 and the sucking up of the container samples from said bottles 2.

The control means 15, the valves 19 and the changeover valve 17 are controlled by the central control unit 18, for example in such a manner that after expiry of the reaction time, with the valve 19 open, the respective container sample is moved via the control means 15 into the storage means 20 associated with the relevant inspection station 8 and the valve 19 is then closed again. The analysis of the container samples stored in an intermediate manner in the storage means 20 is effected one after the other in time by the gas analysis unit 14 by means of corresponding actuation of the changeover valve 17. In general, the control is effected in such a manner that in each case the container sample of one bottle 2 is stored in each storage means 20. If the analysis of the gaseous and/or vaporous reaction product ascertains contamination of one bottle 2, said bottle, prompted by a signal supplied by the gas analysis unit 14, is locked-out again after passing the transport section 5.

In principle, however, it is also possible to store the gaseous and/or vaporous container samples of a plurality of bottles 2 in each storage means 20, it then however no longer being possible to recognize and lock-out individual contaminated bottles 2, but if contamination is ascertained, it is then necessary and/or desired to lockout an entire bottle group within which the contamination has been ascertained.

In the case of this specific embodiment also, the analysis lines 16 and the storage means 20 positioned therein are once again in one possible embodiment rinsed with an inert gaseous and/or vaporous medium, for example with CO₂ gas, nitrogen or sterile air in order, in this manner, to remove residues of a container sample from the analysis lines 16 and the storage means 20.

The present application has been described above by way of possible embodiments. It is obvious that modifications and conversions are possible without departing from the teaching concept underlying the present application.

It has been assumed above that the inspection stations 8 are provided one after the other in the direction of transport A of the transport section 5. In principle, however, it is also possible to realize the inspection stations 8 such that the required and/or desired container flow is converted into a plurality of parallel or substantially parallel container flows, a transport section with at least one inspection station 8 being associated with each container flow. In the case of this embodiment, the analysis of the container samples for gaseous and/or vaporous reaction products is also effected in the common gas analysis unit 14.

### LIST OF REFERENCES

1, 1a Inspection device

2 Bottle

2.1 Bottle mouth

3 Conveyor

4 Conveyor belt

5 Transport section

6, 7 Support belt

8 Inspection station

9 Carrier

10 Crank wheel

11 Injection and analysis head

12 Nozzle tube

13 Double parallel guiding means

14 Gas analysis unit or gas analysis device

15 Control means

16 Analysis line

17 Changeover valve

18 Central control unit

19 Valve

20 Storage means

A Direction of transport of the conveyor 3

B Direction of rotation of the crank wheel 10

1-23. (canceled)

24. Device for inspecting bottles or similar containers (2) by introducing an inspection and/or reaction medium into the respective container (2) as well as through analysis of a gaseous and/or vaporous container sample for gaseous and/or vaporous reaction products removed from the respective container, said device having an inspection station (8) positioned on a transport section (5) for the containers (2), wherein at least two inspection stations (8) are provided at least for the removal of the gaseous and/or vaporous container samples.

25. Device according to claim 24, wherein at least two inspection stations (8) are provided one after the other in the transport direction (A) of the transport section (5).

26. Device according to claim 25, wherein a common gas analysis unit (14) for analyzing the gaseous and/or vaporous container samples is associated with the at least two inspection stations (8).

27. Device according to claim 26, wherein said device comprises a central control unit (18) for controlling the inspection stations (8) and/or the gas analysis unit (14) and/or control valves in the gas paths or analysis lines (16) that connect the inspection stations (8) to the gas analysis unit (14), in such a manner that the container samples supplied from the inspection stations (8) are each analyzed one after the other chronologically in the gas analysis unit (14).

28. Device according to claim 27, wherein at least one inspection station (8) has associated therewith a storage means (20) for storing the container samples supplied by said inspection station (8).

29. Device according to claim 28, wherein the inspection stations (8) with gas paths or analysis lines (16) that connect to the common gas analysis unit (14) are individually blockable, for example by means of control valves (19).

30. Device according to claim 29, wherein the gas paths (16) connecting the inspection stations (8) to the common gas analysis unit (14) and/or the storage means (20) associated with the inspection stations (8) are rinsable with an inert gaseous and/or vaporous medium, for example with an inert gas and/or with sterile air.

31. Device according to claim 30, wherein the at least two inspection stations (8) are each also realized for introducing the inspection and/or reaction medium into the containers (2).

32. Device according to claim 31, wherein the inspection and/or reaction medium is an inspection and/or reaction liquid.

33. Device according to claim 32, wherein the at least two inspection stations (8) are realized for introducing the inspection and/or reaction medium in the warmed-up or heated state.

34. Device according to claim 33, wherein the gas paths (16) connecting the inspection stations (8) to the gas analysis unit (14) and/or the storage means (20) associated with the inspection stations (8) are heatable.

35. Device according to claim 34, wherein the transport section (5) is realized for a single-track container flow.

36. Method for inspecting bottles or similar containers (2) by introducing an inspection and/or reaction medium into the interior of the respective container (2) and by removing a container sample from the respective container (2) as well as through analysis of the container sample for gaseous and/or vaporous reaction products using an inspection station (8) provided on a transport section (5) for the containers (2), wherein the inspection of the containers (2) is effected by at least two inspection stations (8) in such a manner that the container sample is only removed in each case from each container (2) at one inspection station (8).

37. Method according to claim 36, wherein the inspection of the containers (2) is effected by at least two inspection stations (8) that are provided on a common transport section (5).

38. Method according to claim 37, wherein the container samples removed at the inspection stations (8) are analyzed in a common gas analysis unit (14).

39. Method according to claim 38, wherein the introducing of the inspection and/or reaction medium as well as, after expiry of a reaction time, the removal of the container sample are carried out at each inspection station (8).

40. Method according to claim 39, wherein the introducing of the inspection and/or reaction medium into the containers (2) is effected at at least one station that is separated from the inspection stations (8).

41. Method according to claim 40, wherein the analysis of the container samples supplied by the inspection stations (8) is effected staggered in time in such a manner that the container sample of one inspection station (8) is analyzed during the reaction time at another inspection station (8).

42. Method according to claim 41, wherein the inspection and/or reaction medium is supplied to the respective container (2) in the warmed-up or heated state.

43. Method according to claim 42, wherein:
the respective container sample is stored in an intermediate manner in a storage means (20);
an inspection and/or reaction liquid is used as the inspection and/or reaction medium;
the inspection stations (8) with the gas channels or lines (16) connecting to the gas analysis unit (14) and/or their operating elements and/or storage means (20) for storing the container samples are rinsed with an inert medium, for example with an inert gaseous and/or vaporous medium for removing any residue of the container samples; and
the storage means (20) associated with each inspection station (8) and/or the gas path (16) leading to the gas analysis unit (14) are rinsed with the inert medium in each case after removal of the container sample and/or after the analysis of the container sample.
